(19) United States
(12) Patent Application Publication
(10) Pub. No.: US 2025/0206937 A1
(43) Pub. Date: Jun. 26, 2025

(54) ANTIBLOCKING COATING FOR STRUCTURAL MATERIALS

(71) Applicant: Rohm and Haas Company, Collegeville, PA (US)

(72) Inventors: William C. Finch, Ambler, PA (US); Katherine A. Faber, Gilbertsville, PA (US); Drew E. Williams, Norristown, PA (US); Janah C. Szewczyk, Philadelphia, PA (US)

(21) Appl. No.: 18/847,725

(22) PCT Filed: Mar. 21, 2023
(86) PCT No.: PCT/US2023/064759

§ 371 Date: Sep. 17, 2024

Related U.S. Application Data
(60) Provisional application No. 63/322,246, filed on Mar. 22, 2022.

(51) Int. Cl. C08L 33/08; C08K 3/34; C08K 5/54; C08L 91/08; C09D 7/61; C09D 7/63; C09D 7/65; C09D 7/80; C09D 133/08

(52) U.S. Cl. CPC C08L 33/08; C08K 3/346; C08K 5/54; C08L 91/08; C09D 7/61; C09D 7/63; C09D 7/65; C09D 7/80; C09D 133/08

(57) ABSTRACT

Blocking of coated structural components can be minimized by applying and curing a fast-curing anti-blocking topcoat. A suitable antiblocking topcoat comprises the following solid components dissolved or suspended in an aqueous solvent: c) A binder in a quantity sufficient to form a stable coating; d) From 1 weight percent to 20 weight percent of a film-forming high-Tg polymer with a glass transition temperature of at least 80° C.; e) From 1 weight percent to 25 weight percent of a hydrophobic additive; and f) Optionally up to 70 weight percent of a filler, wherein (1) the solids content of the composition is at least 5 weight percent; (2) the weight percentages listed for each of components (a)-(d) are based on the total weight of the aqueous composition; and (3) the pH of the composition is between 2 and 6.

### TECHNICAL FIELD

This application relates to the field of coatings for structural components.

### BACKGROUND

Structural components include a wide variety of solid objects such as beams, planks, sheets, films, tubes and other shaped articles, such as door parts, window parts, fence and deck parts, furniture parts, and housings for mechanical equipment. Structural components are made from a variety of structural materials depending on intended use; examples of structural materials include wood, metal, plastic, concrete, fiberglass and glass.

The exterior surfaces of structural components are frequently coated with one or more coating materials to improve appearance, protect from the environment, improve safety in use and/or provide other desirable properties. Examples of such coatings include a variety of paints, varnishes, shellacs, sealants and curable powder coatings.

“Blocking” is a common problem for coated structural components. Many coating compositions dry to touch quickly but take a longer time to fully cure—maybe even days. Other coating compositions are intentionally soft even after fully cured. Individual structural components may be stacked or bundled as they come off the production line, so that their weight presses their surfaces together. Or a sheet or film may be rolled into a roll as it comes off the production line, so that a surface from one layer in the roll is pressed up against the surface from another layer of the same roll. Time and pressure cause the still-soft coating to adhere to both surfaces that it is pressed between, with the result that the coating binds the two surfaces together, forming a solid block from structural components or layers that are intended to be separate. Separating the surfaces can damage the surface or the coating or both.

For clarity, it should be noted that “curing” of coating compositions can take place by two separate mechanisms: physical drying and chemical curing. See for example Muller et al., Coatings Formulation, 2^{nd} Ed., Vincentz Network GmbH & Co. (2011) at Section 1.1.1 (Solidification of Paints). In physical drying, the surface solidifies by evaporation of solvent such that the surface becomes dry to the touch and adheres to the surface it was applied to. In chemical curing, chemical reactions among molecules in the coating and molecules on the surface further solidify the cohesiveness of the coating and its adhesion to the surface. Curing of coating compositions may involve either or both of these mechanisms. For many coatings, physical drying occurs more quickly than chemical curing, so that the structural component feels dry and is stacked or bundled or rolled before chemical curing is complete; this situation provides common conditions for block formation.

Blocking and methods to avoid it are discussed in coating industry references such as: “Blocking Resistance in Coatings: Composition Factors to Consider”, https://www.lubrizol.com/Coatings/Blog/2019/11/Blocking-Resistance; “Fluoroadditives: Antiblock Characteristics in Architectural Paint Systems”, Paint and Coatings Industry Magazine, https://www.pcimag.com/articles/83026-fluoroadditives-antiblock-characteristics-in-architectural-paint-systems and “EBook A Guide to Applying Powder Coatings”, www.ifscoatings.com.

Sometimes, blocking can be reduced by performing a longer curing cycle on the structural component to cure the coating composition more fully, but longer cure times; require more capital investment for additional facilities and equipment to hold each structural component separate from the others until the coating composition is fully cured. Alternatively, an antiblocking additive can be added to the coating composition, but antiblocking additives add cost and may interfere with adhesion of the coating to the surface that it is applied to. Alternatively, slip sheets or spacers may be placed between surfaces of different structural components to hold the surfaces apart until they are fully cured, such as is commonly seen in boxes of customer-assembled furniture. But slip sheets and spacers add cost and create additional solid waste.

It would be desirable to find a quick, inexpensive and lower-solid-waste method to reduce blocking of structural components.

### SUMMARY

One aspect of the present invention is a method to prevent blocking of structural components comprising the steps of:
1) Providing a structural component that comprises at least one surface (“block-forming surface”) coated by a primary coating composition that is susceptible to blocking;
2) Applying to the block-forming surface an antiblocking topcoat composition that contains
   a) a solvent,
   b) a binder, and
   c) a film-forming high-Tg polymer which has a glass-transition temperature above 80° C.; and
3) Curing the antiblocking topcoat composition under conditions suitable to form an antiblocking topcoat that is not susceptible to blocking, wherein “susceptible to blocking” with respect to a composition means that the composition will adhere to a surface other than the block-forming surface that is pressed against the block-forming surface for at least an hour at temperatures up to 50° C.

A second aspect of the present invention is an aqueous composition that is useful as an antiblocking topcoat composition and comprises the following solid components dissolved or suspended in an aqueous solvent:
a) A binder in a quantity sufficient to form a stable coating;
b) From 1 weight percent to 20 weight percent of a film-forming high-Tg polymer with a glass-transition temperature of at least 80° C.;
c) From 1 weight percent to 25 weight percent of a hydrophobic additive; and
d) Optionally up to 70 weight percent of a filler,

Wherein (1) the solids content of the composition is at least 5 weight percent; (2) the weight percentages listed for each of components (a)-(d) are based on the total weight of the aqueous composition including solvents; and (3) the pH of the aqueous composition is between 2 and 6. The term “solid” and “solids” in this description refers to components that are solid or waxy solids at 25° C., when they are not dissolved or suspended in a solvent. Components (a)-(d) are solids.

A third aspect of the present invention is a structural member that comprises at least one surface coated with:
a. At least one layer of a primary coating composition; and
b. At least one layer of an antiblocking topcoat on top of the primary coating composition, which antiblocking topcoat contains:
   i. a binder in a quantity sufficient to form a stable coating;
   ii. From 1 weight percent to 20 weight percent of a film-forming high-Tg polymer with a glass-transition temperature of at least 80° C.;
   iii. From 1 weight percent to 25 weight percent of a hydrophobic additive; and
   iv. Optionally up to 70 weight percent of a filler.

The method of the current invention allows the structural components with soft or uncured coatings on their surface to be stacked, bundled or rolled without risk of blocking. It uses a cure step that requires less time and cost than would be required to fully cure the residual uncured coating. It avoids the cost and problems that can be associated with antiblocking additives and slip sheets.

### DETAILED DESCRIPTION

The method of the present invention uses an antiblocking topcoat to prevent structural components from blocking during storage and transportation.

Structural components are discussed in the background. Examples of structural components include beams, planks, studs, dowels, cylinders, tubes, sheets, films and other shaped articles. Examples of shaped articles includes doors parts, window parts, fence and deck parts, stair parts, furniture parts, decorative moldings and housings for mechanical equipment.

Structural components may optionally comprise wood, metal, polymer, concrete, fiberglass or glass. In some embodiments, the structural component contains wood, and in some of those embodiments the structural component is in the form of a beam, plank, sheet, stud, dowel or part for a door, window or furniture. In some embodiments, the structural component contains polymer, metal or fiberglass, and in some of those embodiments the structural component is a sheet or film that is rolled.

All solid objects, including the structural components, inherently have surfaces. In the present invention, at least one surface of the structural component (called the “block-forming surface”) comprises a primary coating composition applied to it. The primary coating composition is susceptible to blocking after step (a). By “susceptible to blocking”, we mean that the primary coating composition will adhere to a surface (other than the block-forming surface), if the block-forming surface and the other surface are pressed together for at least an hour under temperatures up to 50° C. In some cases, the adhesion may occur by pressing another surface against the block-forming surface with a pressure of 1 psi or 2 psi or 4 psi for a period of 1 or 2 or 4 or 8 or 24 hours or at least a week at a temperature of 25° C. or 50° C.

The susceptibility to blocking may arise because the primary coating composition is not fully cured. In some embodiments, full curing of the primary coating composition (so that it is not susceptible to blocking) requires require at least 2 hours standing at ambient temperature, or at least 6 hours or at least 24 hours or at least 72 hours or at least a week.

Alternatively, the susceptibility to blocking may arise because the primary coating composition has a low glass-transition temperature that makes it susceptible to blocking even when fully cured. For example, the primary coating composition may have a glass-transition temperature below 50° C. or no more than 40° C. or no more than 30° C. or no more than 25° C. or no more than 20° C. or no more than 10° C. or no more than 0° C.

In some embodiments, the primary coating composition is a paint, varnish, shellac, sealant or weatherable coating. In some embodiments, the primary coating composition is decorative when fully cured, containing optionally pigments or metal flakes. In some embodiments, the primary coating composition is a clear-coat. In some embodiments, the primary coating composition is water-resistant or weather-resistant when fully cured. In some embodiments, the primary coating is wear resistant or scratch resistant when fully cured. In some embodiments, the primary coating is resistant to acids or other chemicals when fully cured.

Primary coating compositions and their components are known and commercially available. In many embodiments, paints comprise a solvent, a binder and pigments. In many embodiments, varnishes comprise a solvent, resin, a drying oil and a drying agent. In many embodiments, shellacs contain a resin and a solvent, optionally with pigments. In many embodiments, weatherable coatings contain a hydrophobic polymer dissolved or emulsified in a solvent. In some embodiments, the solvent used for a primary coating composition is organic, and in some embodiments the solvent is aqueous. The primary coating compositions may also contain polymers, additives and fillers to provide improved weatherability or other properties. Common additives and their use are described in J. Bieleman (ed.), Additives for Coatings, Wiley-VCH Verlag GmbH (2000).

To prevent blocking, an antiblocking topcoat composition is applied to the block-forming surface on top of the partially-cured or fully-cured primary coating composition. The antiblocking topcoat composition contains a solvent, a binder and a film-forming high-Tg polymer with a glass-transition temperature (Tg) above 80° C.

A purpose for the solvent is to dissolve the binder and the high-Tg polymer or hold them in suspension or emulsion, in order to ease the step of applying them to the block-forming surface. The solvent is substantially removed from the block-forming surface during the curing step. For clarity, the term “solvent” does not imply that all components of the antiblocking topcoat composition are soluble in the solvent. Some or all of the components of the antiblocking topcoat composition may be insoluble and held in suspension or emulsion in the solvent.

Solvents for coatings are well-known. In some embodiments the solvent is organic, such as acetone, pentane, hexane, toluene, xylene, mineral spirits, methyl ethyl ketone; n-butyl acetate, ethylene glycol or lower alcohols such as propanol or butanol. In some embodiments the solvent is aqueous. Aqueous solvents may be substantially neutral (pH from 6 to 8), acidic (pH from 2 to 6) or basic (pH from 8 to 12). In some embodiments, the solvent is an acidic aqueous solvent. In some embodiments, organic solvents may have the advantage of dissolving more components of the antiblocking topcoat composition and/or drying faster, but aqueous solvents may have the advantage of reducing emissions of volatile organic compounds from the antiblocking topcoat composition. Solvents are generally commercially available from multiple sources.

A purpose for the binder is to form a film on the block-forming surface and hold solid components of the antiblocking topcoat composition on the block-forming surface after the curing step. Binders for coatings are well-known. Examples of common binders include acrylic polymers, alkyd polymers, polyurethane polymers, epoxy polymers, polyester polymers and phenolic resins. Examples of other known binders include certain natural resins and starches, styrene-butadiene polymers and silanes. Examples are described in publications such as U.S. Pat. No. 6,660,788 B2, European Patent Publication EP 0 819 744 A2, German Patent Publication DE 3,123,598A1, and “Paints” published by Department of Chemistry, University of York at https://www.essentialchemicalindustry.org/materials-and-applications/paints.html (Mar. 18, 2013).

In certain embodiments, the binder comprises an acrylic polymer. An acrylic polymer is a polymer or copolymer that contains repeating units derived from acrylic monomers. Acrylic monomers include acrylic acid, methacrylic acid and their esters. Exemplary esters used in acrylic monomers include alkyl esters such as alkyl groups containing 1-8 carbon atoms or 1-4 carbon atoms or in some cases methyl groups or ethyl groups. Particularly useful acrylic monomers are acrylic acid, methacrylic acid, butyl acrylate, 2-ethylhexyl acrylate, methyl acrylate, ethyl acrylate, methyl methacrylate and ethyl methacrylate.

Exemplary acrylic polymers may contain at least 70 percent repeating units derived from acrylic monomers, or at least 80 percent or at least 90 percent or at least 95 percent. Exemplary acrylic polymers may contain up 100 percent repeating units derive derived from acrylic monomers. Some exemplary acrylic polymers are copolymers containing units derived from two or more acrylic monomers, such as copolymers of butyl acrylate with methyl methacrylate and/or methacrylic acid. Some exemplary acrylic polymers may further contain repeating units derived from non-acrylic ethylenically unsaturated comonomers, such as ethylene, propylene, butylene or styrene.

The selection of acrylic monomers and their proportions are governed by the intended use of the acrylic polymer. Binders frequently have a glass-transition temperature (Tg) of at least −45° C. and at most +65° C. . . . Binders that will be subjected to large thermal expansion under cold temperatures, such as outdoor coatings in cold climates, may be selected to have a low Tg such as at most −15° C. or −20° C. or −30° C. Binders that will be subjected to little thermal expansion, such as indoor coatings, may have higher Tg such as at least 0° C. or at least 10° C. Increasing content of certain monomers such as methyl methacrylate is known to increase Tg of the resulting polymer, and increasing content of other monomers such as butyl acrylate is known to reduce Tg of the resulting polymer.

Binders must be film-forming under the conditions at which they are applied to the intended substrate. “Film-forming” means that a substance is capable of forming a film upon application to a solid surface. The ability of polymers and their solutions or emulsions to be film-forming is known and described in publications such as: P. A. Steward et al., “An Overview of Polymer Latex Film Formation and Properties”, 86 Advances in Colloid and Interface Science at 195-267 (2000) and J. Guerts et al., “New Waterborne Acrylic Binders for Zero VOC Paints”, 5 J. Coating Technol. Res. at 57-63 (2008). Commonly, the film-forming ability of polymers increases with lower molecular weight and/or lower Tg and decreases with higher molecular weight and/or higher Tg. Binders with a Tg above 25° C. may need additives to help make them film-forming, whereas lower Tg polymers are generally more film-forming.

In some embodiments, the monomer mixture is selected so that the binder is water-soluble. In other embodiments, the binder is insoluble in water but is held in suspension using emulsifiers. Emulsifiers maintain insoluble elements in suspension in an aqueous solvent. Emulsifiers are generally surfactants, such as anionic and nonionic surfactants. For example, some common emulsifiers are fatty alkyl sulfates such as sodium lauryl sulfate, alcohol ether sulfates, aryl sulfonates such as branched sodium dodecyl benzene sulfonate, alkyldiphenyloxide disulfonates such as disodium lauryl phenyl ether disulfonate, nonylphenol ether sulfates such as ammonium nonylphenol ether sulfate, fatty alcohol ethoxylates, nonylphenol ethoxylates, or alkyl phosphate esters such as ammonium phosphate, polyoxyethylene tridecyl ether. Suitable emulsifiers are available under the trademarks DOWSIL™, TERGITOL™, TRITON™. RHODAFAC™, RHODACAL™, DISPONIL™, LUTENSOL™ and DOWFAX™

Examples of binders that are commercially available include acrylic polymers and polymer emulsions available from the Dow Chemical Company under the RHOPLEX™, PARALOID™, and MAINCOTE™ trademarks.

A purpose for the film-forming high-Tg polymer is to add a solid component to the antiblock topcoat that does not soften at ordinary temperatures under which the structural component might be stored or transported. Suitable high-Tg polymers are known and commercially available. Examples of high-Tg polymers include certain acrylic, polystyrene, polyurethane, poly(vinyl alcohol), vinyl acetate ethylene, vinyl acrylic, styrene acrylic, and styrene butadiene polymers. In some embodiments, the high-Tg polymer has a glass transition temperature (Tg) of at least 85° C. or at least 90° C. or at least 95° C. or at least 100° C. There is no maximum Tg for the high-Tg polymer, but Tg higher than 200° C. or 150° C. would not usually be necessary.

The high-Tg polymer must be film-forming. Commonly, the film-forming ability of polymers increases with lower molecular weight and/or lower Tg and decreases with higher molecular weight and/or higher Tg. In some embodiments, additives can be added to the high-Tg polymer to improve its ability to form films. In some embodiments, the molecular weight of the high-Tg polymer can be kept lower to improve its ability to form films.

In some embodiments, the high-Tg film-forming polymer is water-soluble or water-swellable under selected conditions. Without intending to be bound, we hypothesize that the interaction of the water-soluble or water-swellable polymer with water can give added flexibility to a higher molecular weight and higher Tg polymer, which increases its ability to be film-forming. Certain acrylic polymers can be suspended in emulsions under acidic conditions but are water-soluble or water-swellable under neutral or basic conditions. Aqueous emulsions of such water-soluble or water-swellable film-forming high-Tg polymers are commercially available, such as from The Dow Chemical Company under the ACRYSOL™ ASE trademark.

In some embodiments, the antiblocking topcoat composition further comprises one or more hydrophobic additives. One purpose for the hydrophobic additives may be to improve the water-repellency of the antiblock topcoat, which can minimize the risk that the antiblock topcoat softens with continuing exposure to moisture or high humidity. Hydrophobic additives for coatings are known and commercially available. Hydrophobic additives include various waxes (such as paraffin waxes and high-melting waxes); organosilanes, siloxanes and silicones (such as octyl triethoxysilane and polydimethylsiloxane) and hydrophobic polymers (such as polyethylene, polypropylene and polytetrafluoroethylene). In some embodiments, the hydrophobic additives have a melting temperature of at least 60° C. or at least 70° C. or at least 80° C. or at least 85° C. or at least 90° C. There is no required maximum melting temperature for the hydrophobic additive, but a melting point higher than 200° C. or 150° C. would not usually be necessary. In an aqueous antiblocking topcoat composition, the hydrophobic additives may be suspended in the composition using emulsifiers as previously described. Production of emulsified hydrophobic additives is described in publications such as U.S. Pat. Nos. 3,096,232 and 6,033,736. Examples of suitable hydrophobic additives are commercially available under the trademarks: DOWSIL™

(The Dow Chemical Company), Michem Dispersion (Michelman), Lubronil and Wükonil (Münzing) and Aquacer (BYK).

In some embodiments, the antiblocking topcoat composition further comprises one or more fillers. Fillers are solid particles added to a coating to improve properties and/or reduce cost. In compositions of this invention it is hypothesized, without intending to be bound, that the filler can help create an uneven surface texture in the antiblock topcoat that helps the topcoat to resist blocking. Suitable fillers for coatings are known and commercially available. Examples of suitable fillers include clays such a kaolin, diatomaceous earth, glass powder and microspheres, aluminum hydroxide and various powdered minerals such as calcium carbonate, dolomite, feldspar, mica, quartz, silica and silicates, talc and metal carbonates. Other examples of suitable fillers include common mineral pigments, such as titanium dioxide and carbon black. Fillers and their production and use are described in publications such as: Gysau, Fillers for Paints (3^{rd} Ed.), Vincentz Network GmbH & Co. (2017); and “Functional Silicate Fillers: Basic Principles”, Painting & Coatings Industry (Aug. 1, 2002) (https://www.pcimag.com/articles/84909-functional-silicate-fillers-basic-principles).

In some embodiments, the filler is a high surface-area material. Surface area is frequently measured based on oil absorption value, as described in ASTM D281 (Standard Test Method for Oil Absorption of Pigments by Spatula Rub-Out). In some embodiments, the filler used in the present invention may have an oil absorption value of at least 25 g/100 g or at least 30 g/100 g or at least 40 g/100 g or at least 50 g/100 g. There is no maximum surface area, but an oil absorption value above 250 g/100 g may be unnecessary.

Some common fillers are insoluble and may be suspended in the antiblocking coating composition using an emulsifier.

Examples of suitable fillers are commercially available under the following trademarks: ASP (BASF), Minex and Imsil (Covia), Zoco (American Zinc Recycling), Opacilite and DiaFil and Mica MU (Imerys), Lo-Vel (PPG), Hakuenka and Omyawhite (Omya).

As previously described, the binder, high-Tg polymer, hydrophobic additive and filler are solids in the antiblocking topcoat composition. In some embodiments, it is advantageous to maximize solids in the antiblocking topcoat composition in order to reduce drying time and to minimize volatile organic solvents released from the composition during drying. In some embodiments, the solids content of the antiblocking topcoat composition is at least 5 weight percent or at least 10 weight percent or at least 15 weight percent or at least 20 weight percent or at least 24 weight percent, based on the total weight of the composition. There is no maximum solids content, as long as the antiblocking topcoat composition can be applied smoothly and easily. In some embodiments, the solids content of the aqueous composition is at most 70 weight percent or at most 50 weight percent or at most 40 weight percent weight percent or at most 33 weight percent, based on the total weight of the composition.

The binder should be in a quantity sufficient to form a stable coating, which means that the solid components of the composition adhere securely to the film-forming surface. In some embodiments of the antiblocking topcoat composition the binder makes up at least 0.25 weight percent of the composition (including solvent) or at least 0.5 weight percent or at least 1 weight percent or at least 1.2 weight percent. In some embodiments of the antiblocking topcoat composition the binder makes up at most 25 weight percent of the composition (including solvent) or at most 20 weight percent or at most 10 weight percent or at most 5 weight percent or at most 3 weight percent. In some embodiments of the antiblocking topcoat composition the binder makes up at least 1 weight percent of the solids (excluding solvent) or at least 2 weight percent or at least 3 weight percent or at least 5 weight percent. In some embodiments of the antiblocking topcoat composition the binder makes up at most 50 weight percent of the solids (excluding solvent) or at most 20 weight percent or at most 10 weight percent.

In some embodiments of the antiblocking topcoat composition the film-forming high-Tg polymer makes up at least 1 weight percent of the composition (including solvent) or at least 2 weight percent or at least 3 weight percent or at least 5 weight percent. In some embodiments of the antiblocking topcoat composition the film-forming high-Tg polymer makes up at most 20 weight percent of the composition (including solvent) or at most 15 weight percent or at most 10 weight percent. In some embodiments of the antiblocking topcoat composition the film-forming high-Tg polymer makes up at least 2 weight percent of the solids content (excluding solvent) or at least 4 weight percent or at least 6 weight percent or at least 10 weight percent. In some embodiments of the antiblocking topcoat composition the high-Tg polymer makes up at most 50 weight percent of the solids content (excluding solvent) or at most 40 weight percent or at most 30 weight percent. In some embodiments of the antiblocking topcoat composition the hydrophobic additive makes up at least 1 weight percent of the composition (including solvent) or at least 2 weight percent or at least 3 weight percent. In some embodiments of the antiblocking topcoat composition the hydrophobic additive makes up at most 20 weight percent of the composition (including solvent) or at most 15 weight percent or at most 10 weight percent. In some embodiments of the antiblocking topcoat composition the hydrophobic additive makes up at least 2 weight percent of the solids content (excluding solvent) or at least 5 weight percent or at least 10 weight percent. In some embodiments of the antiblocking topcoat composition the hydrophobic additive makes up at most 40 weight percent of the solids content (excluding solvent) or at most 30 weight percent or at most 20 weight percent.

In some embodiments of the antiblocking topcoat composition the filler makes up at least 5 weight percent of the composition (including solvent) or at least 8 weight percent or at least 10 weight percent or at least 12 weight percent. In some embodiments of the antiblocking topcoat composition the filler makes up at most 50 weight percent of the composition (including solvent) or at most 30 weight percent or at most 20 weight percent. In some embodiments of the antiblocking topcoat composition the filler makes up at least 5 weight percent of the solids content (excluding solvent) or at least 10 weight percent or at least 20 weight percent or at least 30 weight percent or at least 40 weight percent. In some embodiments of the antiblocking topcoat composition the filler makes up at most 70 weight percent of the solids content (excluding solvent) or at most 60 weight percent.

Optionally, the antiblocking topcoat composition may also contain other additives, such as thickeners, defoamers, surfactants, stabilizers, wetting agents, flow-levelling and coalescing agents, antioxidants and biocides. Common additives and their use are described in J. Bieleman (ed.), Additives for Coatings, Wiley-VCH Verlag GmbH (2000). In some embodiments, the other additives make up no more than 5 weight percent of the aqueous composition (including solvent) or no more than 3 weight percent or no more than 2 weight percent or no more than 1 weight percent. In some embodiments, the other additives make up no more than 10 weight percent of the solids in the aqueous composition or no more than 5 percent or no more than 2 weight percent.

In the method of the present invention, it is advantageous for the components of the antiblocking topcoat composition to be selected so that the antiblocking topcoat composition cures to the extent that it is not susceptible to blocking quickly under the conditions of the curing step. A faster cure rate for the antiblocking topcoat composition permits the structural components to be stacked, bundled or rolled, without taking the time to fully cure the primary coating composition. In some embodiments, the components of the antiblocking topcoat composition are selected so that the antiblocking topcoat composition is not susceptible to blocking after curing under the conditions of the curing step for a period of no more than 1 hour or no more than 30 minutes or no more than 15 minutes or no more than 5 minutes or no more than 2 minutes or no more than 1 minute.

An aqueous antiblocking topcoat composition that is particularly useful in the method of this invention comprises the following solid components dissolved or suspended in an aqueous solvent:
a) From 1 weight percent to 10 weight percent of a binder;
b) From 1 weight percent to 20 weight percent of a film-forming high-Tg polymer with a glass-transition temperature of at least 80° C.;
c) From 1 weight percent to 25 weight percent of a hydrophobic additive; and
d) Optionally up to 70 weight percent of a filler,
   wherein (1) the solids content of the composition is at least 5 weight percent; (2) the weight percentages listed for each of components (a)-(d) are based on the total weight solids in the aqueous composition; and (3) the pH of the aqueous composition is between 2 and 6.

The binder has the description, exemplary embodiments and exemplary concentrations previously described. In some embodiments, it is an acrylic polymer with a Tg no higher than 25° C. . . .

The film-forming high-Tg polymer has the description, exemplary embodiments and exemplary concentrations previously described. In some embodiments, the film-forming high-Tg polymer is an acrylic polymer, and in some embodiments the acrylic polymer is emulsified in acidic solutions and is water-soluble or water-swellable in neutral solutions or in basic solutions.

The hydrophobic additive and filler have the description, exemplary embodiments and exemplary concentrations previously described. The aqueous composition may also have other additives as previously described.

In some embodiments, the pH of the aqueous composition is at least 4 or at least 5. In some embodiments, the pH of the aqueous composition is at most 7 or at most 6.

In the method of the present invention, the antiblocking topcoat composition is applied to the block-forming surface. Known application methods may be used, such as spraying, brushing, rolling, curtain coating or dipping. In some embodiments, the antiblocking topcoat composition is sprayed on the block-forming surface.

After it is applied to the block-forming surface, the antiblocking topcoat composition is subjected to a curing step until it is no longer susceptible to blocking (as that term is previously defined). In some embodiments, the temperature of the curing step is at least 20° C. or at least 35° C. or at least 50° C. or at least 75° C. or at least 100° C. In some embodiments, the temperature of curing is at most 300° C. or at most 250° C. or at most 225° C. or at most 200° C. or at most 160° C. In some embodiments, the curing is accompanied by airflow to carry away solvent from the antiblocking composition. In some embodiments, the curing takes place under an air atmosphere, and in some embodiments the curing takes place under an inert atmosphere such as nitrogen. In some embodiments, the curing step is completed in no more than 1 hour or no more than 30 minutes or no more than 15 minutes or no more than 5 minutes or no more than 2 minutes or no more than 1 minute.

After the curing step is done, the block-forming surface of the structural component contains at least one layer of primary coating composition topped by at least one layer of antiblocking topcoat. Areas of the primary coating composition may be susceptible to blocking, except that the cured antiblocking topcoat prevents the primary coating composition from contacting surfaces other than the block-forming surface and thus prevents blocking. In some embodiments, the block forming surface (with the antiblocking topcoat) can be pressed against another surface for at least 1 hour or at least 6 hours or at least 24 hours without substantial blocking. In some embodiments, the temperature during that pressure can be up to 50° C. In some embodiments, the pressure may be up to 1 psi or at least 2 psi or at least 3 psi. In some embodiments, the relative humidity may be up to 50% or 57% or 90% or 100%.

The contents of the dried antiblocking topcoat reflect the solids contents of the antiblocking topcoat composition that was applied and cured, having the same exemplary components and concentrations. In some embodiments, the cured antiblocking topcoat contains no more than 5 weight percent solvent, or no more than 3 weight percent or no more than 1 weight percent or no more than 0.5 weight percent. There is no required content of solvent in the topcoat, but in some cases it may be impractical to remove solvent to a content below 0.1 weight percent. There is no requisite thickness for the antiblocking topcoat, but in some embodiments the average thickness of the topcoat is at least 5 μm or at least 10 μm or at least 25 μm and in some embodiments the average thickness is at most 600 μm or at most 500 μm or at most 300 μm.

Unlike many topcoats used on structural components, the antiblocking topcoats of the present invention do not need to be highly weatherable or wear-resistant. The antiblocking topcoat only needs to remain in place until the primary coating composition is fully cured and not capable of forming blocks. In many cases, the primary coating composition is fully cured within a few days or a few weeks after the curing step is completed. In many cases, the primary coating composition is fully cured before the structural component is received by the user and placed in service. In many embodiments, the antiblocking topcoat is no longer needed after the structural component is place in service. The antiblocking topcoat can be allowed to wear off or weather off with time, like a floor wax or polish. In some embodiments, this difference in use may influence the selection of additives in the antiblocking topcoat composition. Additives that provide oxidation resistance, light resistance, scratch resistance, wear resistance and weather resistance may be unimportant and may be excluded from the antiblocking topcoat composition. Antiblocking topcoats that are intended to wear off or weather off in ordinary use can be called sacrificial topcoats.

In some embodiments, at least 25 weight percent of the topcoat has worn off the structural component after 6 months of ordinary use, or at least 50 weight percent or at least 75 weight percent. In other embodiments, the structural component may be used in a sheltered use, such as inside a wall, and essentially none of the topcoat is worn off.

### EXAMPLES

The invention is further illustrated by the following examples, which are demonstrative but not limiting. Comparative examples are included to show the beneficial impact of some components of the invention.

### Substrate Preparation

A slow-curing primary coating composition is prepared. An aqueous suspension of pigments is prepared by blending the materials listed in Table 1A until a suspension is formed.

TABLE 1A

| | | Parts by |
|---|---|---|
| Material | Identification | weight |
| Water | | 15.22 |
| Dispersant | TAMOL ™ 851 dispersant, | 0.98 |
| | The Dow Chemical Company | |
| Defoamer | Dee Fo 1015 Defoamer, | 0.10 |
| | Munzing Chemie, GmbH | |
| Titanium Dioxide | Ti-Pure R 960 pigment, Chemours | 5.38 |
| Calcium Carbonate | Snowhite 12 pigment, Omya, Inc | 29.20 |
| Pigment⁴ | | |

After the suspension is formed, the shear in the mixture is reduced and the materials listed in Table 1B are added in the order listed. Mixing is continued for an additional hour or until smooth.

TABLE 1B

| | | Parts by |
|---|---|---|
| Material | Identification | weight |
| Polymer Emulsion¹ | | 44.65 |
| Aqueous Ammonia | | 0.06 |
| (28 wt. %) | | |
| Propylene Glycol | | 0.71 |
| Water | | 2.54 |
| Cellulose ether | WALOCEL MT 6000 PV, | 0.14 |
| Thickener | The Dow Chemical Company | |
| Coalescents | DOWANOL DPnB solvent, | 0.62 |
| | The Dow Chemical Company | |

¹Polymer emulsion contains a random copolymer of 86 percent butyl acrylate, 12.3 percent methyl methacrylate and 1.7 methacrylic acid having a Tg of −35° C. in a concentration of 55% solids

The materials in Tables 1A and 1B add up to a total of 100 weight percent. The resulting primary coating composition contains 41% solids by volume and 56% solids by weight. The primary coating composition is applied to aluminum Q panels (A412 mill finish, Q Labs Corporation) using a 100 mm wide GARDCO™ Multiple Clearance Square Applicator (Paul N Gardner Company, Inc.) to cast a 381 micron thick wet film onto the substrate. Each coated panel is dried at ambient conditions for 7 days (21° C. and ˜50% RH).

### Topcoat Composition and Application:

The amount of water shown in Table 2 is added to a vessel, and then the other ingredients shown in Table 2 are added to the vessel in the order and quantity shown in Table 2 and blended until homogeneous. Quantities shown all indicate parts by weight. The pH of each topcoat composition is tested.

Each topcoat composition is applied to several of the coated substrates previously described, using a 50 mm wide GARDCO™ Multiple Clearance Square Applicator (Paul N Gardner Company, Inc) to cast a 76 micron thick wet film onto the coated substrate. Some of the top-coated substrates are dried at ambient conditions (about 21° C. and about 50% relative humidity) for 1 to 3 days. Others of the top-coated substrates are dried for 24 hours in an oven at 50° C. and about 30% relative humidity, followed by 1-7 days of equilibration at ambient conditions.

### Testing

Ambient Temperature Blocking: Aluminum Q panels (A612 mill finish, Q Labs Corporation) are cut to 5.12 cm×5.12 cm (2 in x 2 in) squares and the cut squares are placed directly onto a 5.12 cm×5.12 cm (2 in x 2 in) square of each ambient temperature cured top coated panel. Each stack of panels is subjected to 10 psi pressure. The pressure is maintained for 4 hours, and then removed. After 1 min, the Q panel is removed to determine block resistance. The nature of coating damage and the amount of removed coating was recorded. If the Q panel is easily removed, the coating passes. If removing the Q panel requires effort or damages either the primary coating or the antiblocking topcoat, the coating fails. For each coated Q panel, a total of two squares of coating are tested at the indicated weight loading and the results are accepted if they are the same (pass or fail). The results are shown in Table 2.

The same test is performed on two squares of the coated Q-panel substrate that have the primary coating but no antiblocking topcoat. The squares without a topcoat also fail.

High Temperature Blocking: The previous test is repeated for the oven-cured top-coated panels, except the pressurized panels are placed in an oven at 50° C. and about 30% relative humidity for 4 hours before testing. The results are shown in Table 2.

TABLE 2

| | | | | | | | | | | | Comparative | | |
|---|---|---|---|---|---|---|---|---|---|---|---|---|---|
| | | Inventive Examples | | | | | | | | | Examples | | |
| Example | Material | 2 | 3 | 4 | 5 | 6 | 7 | 9 | 10 | 12 | 8 | 11 | 13 |
| Water | | 50.00 | 59.44 | 41.44 | 59.44 | 49.44 | 49.44 | 38.09 | 52.61 | 50.00 | 63.08 | 64.71 | 50.00 |
| Binder | RHOPLEX ™AC- | 2.62 | 2.62 | 2.62 | 2.62 | 2.62 | 2.62 | 2.62 | — | 2.62 | 2.62 | 3.39 | 2.62 |
| | 464 | | | | | | | | | | | | |
| Defoamer | Dee Fo 1015 | 0.14 | 0.14 | 0.14 | 0.14 | 0.14 | 0.14 | 0.14 | 0.14 | 0.14 | 0.14 | 0.18 | 0.14 |
| | Defoamer | | | | | | | | | | | | |
| Hydrophobic | Aquacer 539 | 11.44 | 2.00 | 20.00 | — | — | — | 11.43 | 11.44 | 11.44 | 11.43 | 14.80 | 11.44 |
| Additive | Paraffin | | | | | | | | | | | | |
| Hydrophobic | DOWSIL ™ 87 | — | — | — | 2.00 | 12.00 | — | — | — | — | — | — | — |
| Additive | Silane | | | | | | | | | | | | |
| Hydrophobic | Aquacer 593 | — | — | — | — | — | 12.00 | — | — | — | — | — | — |
| Additive | Polypropylene | | | | | | | | | | | | |
| Filler | ASP 170 | 13.07 | 13.07 | 13.07 | 13.07 | 13.07 | 13.07 | 24.99 | 13.07 | 13.07 | — | 16.92 | 13.07 |
| | Pulverized | | | | | | | | | | | | |
| | Kaolin | | | | | | | | | | | | |
| High-Tg | ACRYSOL ™ | 22.73 | 22.73 | 22.73 | 22.73 | 22.73 | 22.73 | 22.73 | 22.74 | 22.73 | 22.73 | — | 22.73 |
| Hydrophobic | ASE-60 | | | | | | | | | | | | |
| Polymer | | | | | | | | | | | | | |
| Emulsion | | | | | | | | | | | | | |
| Totals | | 100.00 | 100.00 | 100.00 | 100.00 | 100.00 | 100.00 | 100.00 | 100.00 | 100.00 | 100.00 | 100.00 | 100.00 |
| pH | | 5.5 | 5.2 | 5.3 | 5.2 | 4.8 | 6.0 | 5.5 | 5.3 | 5.5 | 5.5 | 8.5 | 7.0 |
| Ambient | | Pass | Pass | Pass | Pass | Pass | Pass | Pass | Pass | | Pass | Pass | —¹ |
| Test | | | | | | | | | | | | | |
| High | | Pass | Pass² | Pass | Pass | Pass | Pass | Pass | Pass | Pass | Fail | Fail | —¹ |
| Temperature | | | | | | | | | | | | | |
| Test | | | | | | | | | | | | | |

¹Solution became too viscous to apply, so it could not be tested.
²Solution required 1 minute cooling before testing in order to Pass.

### Test Methods

Glass Transition Temperature: ASTM E1356-08 (2014) Assignment of the Glass Transition Temperatures by Differential Scanning calorimetry

### Oil Absorption: ASTM D281 (2021) Oil Absorption of Pigments by Spatula Rub-Out

1. An aqueous composition comprising the following solid components dissolved or suspended in an aqueous solvent:
a) A binder in a quantity sufficient to form a stable coating;
b) From 1 weight percent to 20 weight percent of a film-forming high-Tg polymer with a glass-transition temperature (Tg) of at least 80° C.;
c) From 1 weight percent to 25 weight percent of a hydrophobic additive; and
d) Optionally up to 70 weight percent of a filler,
wherein (1) the solids content of the composition is at least 5 weight percent; (2) the weight percentages listed for each of components (a)-(d) are based on the total weight of the aqueous composition including solvent; and (3) the aqueous composition has a pH between 2 and 6.

2. The aqueous composition of claim 1, wherein the binder comprises an acrylic polymer with a Tg of no more than 25° C.

3. The aqueous composition of claim 1, wherein the high-Tg polymer comprises an acrylic polymer with a glass-transition temperature of at least 90° C.

4. The aqueous composition of claim 1, wherein the high-Tg polymer can form emulsions in an acidic solution but is water-soluble or water-swellable in a neutral solution or in a basic solution.

5. The aqueous composition of claim 1, wherein the hydrophobic additive comprises a wax, a silane or a polyolefin polymer.

6. The aqueous composition of any one of claim 1, which comprises at least 8 weight percent filler based on the total weight of the composition.

7. The aqueous composition of claim 1, wherein
a) the binder comprises an acrylic polymer with a Tg of no more than 25° C. and makes up from 1 to 10 weight percent of the aqueous composition;
b) the high-Tg polymer comprises an acrylic polymer with a glass-transition temperature of at least 90° C. and makes up at least 2 weight percent of the aqueous composition;
c) the hydrophobic additive comprises a wax, a silane or a polyolefin polymer and makes up at least 2 weight percent of the aqueous composition;
d) the filler makes up at least 8 weight percent of the aqueous composition;
e) the solids content of the aqueous composition is at least 20 weight percent, based on the total weight of the composition.

8. The aqueous composition of claim 1, wherein the composition contains essentially no antioxidant additives or light stabilizing additives.

9. A method to prevent blocking of structural components comprising the steps of:
a) Providing a structural component that comprises at least one surface (“block-forming surface”) coated by a primary coating composition that is susceptible to blocking;
b) Applying to block-forming surface an antiblocking topcoat composition that contains
i) a solvent,
ii) a binder and
iii) a film-forming high-Tg polymer which has a glass-transition temperature above 80° C.; and
c) Curing the antiblocking topcoat composition under conditions suitable to form an antiblocking topcoat that is not susceptible to blocking,
wherein “susceptible to blocking” with respect to a composition means that the composition will adhere to a surface other than the block-forming surface that is pressed against the block-forming surface for at least an hour at temperatures up to 50° C.

10. A structural member that comprises at least one surface coated with:
a) At least one layer of a primary coating composition; and
b) At least one layer of an antiblocking topcoat on top of the primary coating composition, which antiblocking topcoat contains:
i) From 1 weight percent to 50 weight percent of a binder;
ii) From 2 weight percent to 50 weight percent of a film-forming high-Tg polymer with a glass-transition temperature of at least 80° C.;
iii) From 2 weight percent to 40 weight percent of a hydrophobic additive; and
iv) Optionally up to 70 weight percent of a filler.
